(19) United States
(12) Patent Application Publication
(10) Pub. No.: US 2019/0051876 A1
(43) Pub. Date: Feb. 14, 2019

(54) VEHICLE BATTERY RETAINING APPARATUS AND METHOD OF USE

(71) Applicant: Lowell Ray Brown, Irving, TX (US)

(72) Inventor: Lowell Ray Brown, Irving, TX (US)

(21) Appl. No.: 16/100,989

(22) Filed: Aug. 10, 2018

Related U.S. Application Data
(60) Provisional application No. 62/543,715, filed on Aug. 10, 2017.

(51) Int. Cl. H01M 2/10; B60R 16/04

(52) U.S. Cl. CPC H01M 2/1083; H01M 2220/20; B60R 16/04

(57) ABSTRACT

A battery retaining apparatus for securing one or more batteries in place within a vehicle, the battery retaining apparatus includes a base bar to extend across the one or more batteries, the bas bar has bolt receiving holes; bolts to insert through the bolt receiving holes; a top bar to engage with the base bar to prevent access to the bolts; and a lock extending through the top bar; the lock is to lock the top bar and the base bar together, thereby preventing access to the bolts; and the battery retaining apparatus prevents removal of the one or more batteries.

### BACKGROUND

### 1. Field of the Invention

The present invention relates generally to vehicle battery retaining systems, and more specifically, to a vehicle battery retaining system for providing a locking mechanism to prevent removal of one or more batteries from a vehicle system.

### 2. Description of Related Art

Vehicle battery retaining systems are well known in the art and are effective means to hold one or more batteries. For example, FIGS. 1A and 1B depict a conventional vehicle battery retaining system 101 having one or more batteries 103a-c secured in a battery holding apparatus 105 via a bar 107 and a plurality of bolts 109. In system 101, the bar 107 is removed by removing the bolts, as shown in FIG. 1B, thereby allowing for removal of batteries 103a-c.

One of the problems commonly associated with system 101 is security. For example, the bolts can be easily removed, thereby providing an easy way for the one or more batteries to be stolen. In addition, it is common for bar 107 to be plastic, thereby providing opportunity for the bar to break.

Accordingly, although great strides have been made in the area of battery retaining systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are simplified top views of a common battery retaining system;

FIG. 2 is a top view of a battery retaining system in accordance with a preferred embodiment of the present application;

FIG. 3 is an exploded oblique view of a retaining apparatus of FIG. 2;

FIG. 4 is an oblique view of the retaining apparatus of FIG. 3;

FIG. 5 is a cross sectional view of the top bar and base bar of FIG. 2; and

FIG. 6 is a flowchart of the method of FIG. 2.

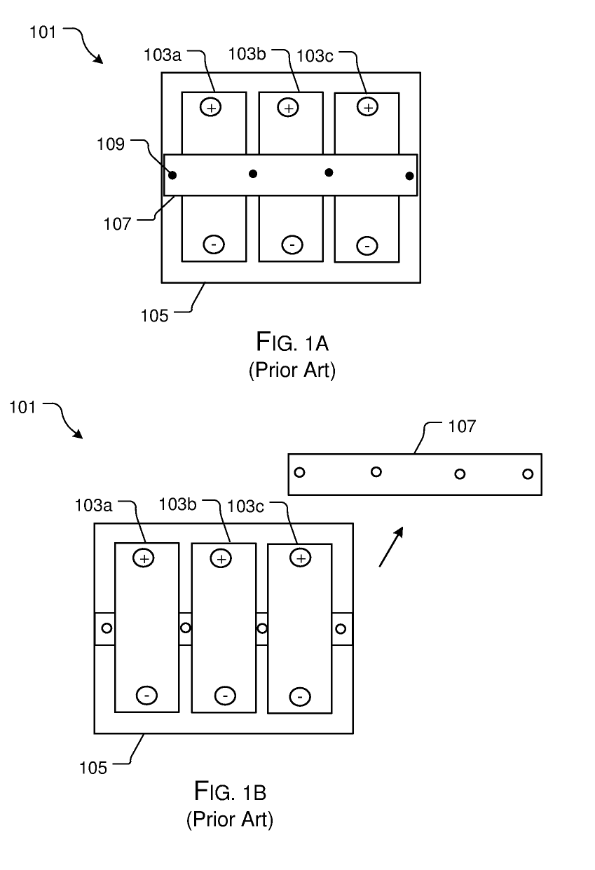

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional battery retaining systems. Specifically, the present invention provides a means to block access to a plurality of bolts positioned to secure one or more batteries in place. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

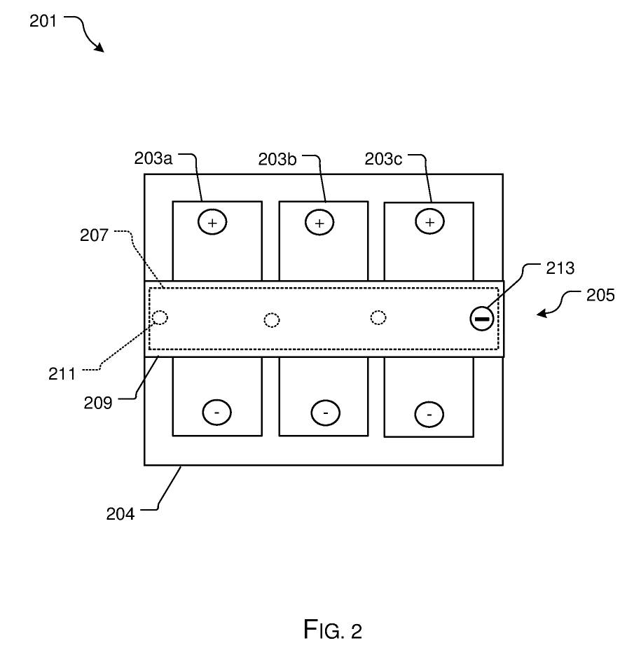

Referring now to the drawings wherein like reference characters identify corresponding or similar elements throughout the several views, FIG. 2 depicts a simplified top view of a battery retaining system 201 in accordance with a preferred embodiment of the present application. It will be appreciated that system 201 overcomes one or more of the above-listed problems commonly associated with conventional battery retaining systems.

In the contemplated embodiment, system 201 includes one or more batteries 203a-c secured within a battery holding apparatus 204 via a battery retaining apparatus 205. Battery retaining apparatus 205 includes a base bar 207 and a top bar 209, wherein a plurality of bolts 211 secure the base bar 207 over the one or more batteries to retaining the batteries in place. Top bar 209 is positioned and secured to base bar 207 to prevent access to the one or more bolts, thereby blocking removal of the bolts.

It is contemplated that top bar 209 can secure to base bar 207 via various means. One means contemplated is the use of locking slip nuts to secure the two bars together. After securing bar 209 on top of bar 207, a lock 213 extending through bar 209 secures the two bars together, thereby preventing access to bolts 211 until being unlocked via a key. Although a simple lock and key mechanism is described and shown, it is contemplated that various locking devices including an electric lock is contemplated.

It should be appreciated that one of the unique features believed characteristic of the present application is the configuration of the top bar being locked to the base bar, thereby preventing access to the plurality of bolts. It should be understood that the bolts must be removed in order to access the one or more batteries for removal, therefore, the top bar prevents unwanted removal of the one or more batteries by requiring unlocking before removal.

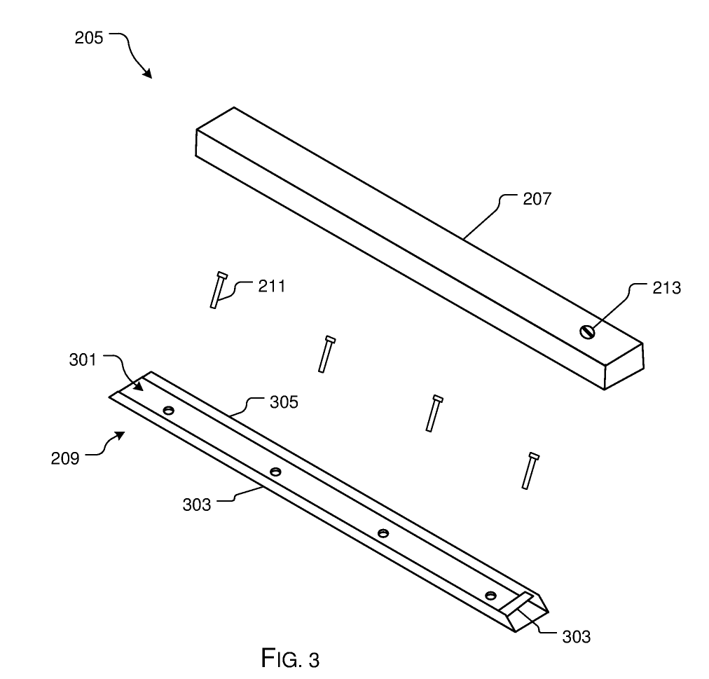

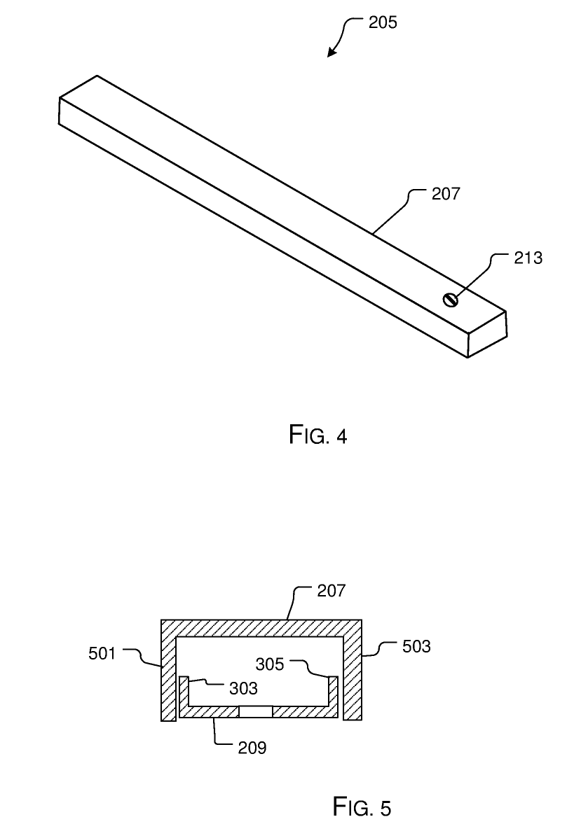

In FIG. 3 an oblique exploded view of apparatus 205 is shown. In this embodiment, base bar 209 includes a channel 301 formed by two sides 303, 305, wherein the plurality of bolts 211 are secured within the channel. Bar 209 further includes a ledge or lip 307 configured to engage with lock 213. As shown in FIG. 4, when secured together, bars 207, 209 prevent access to bolts 211.

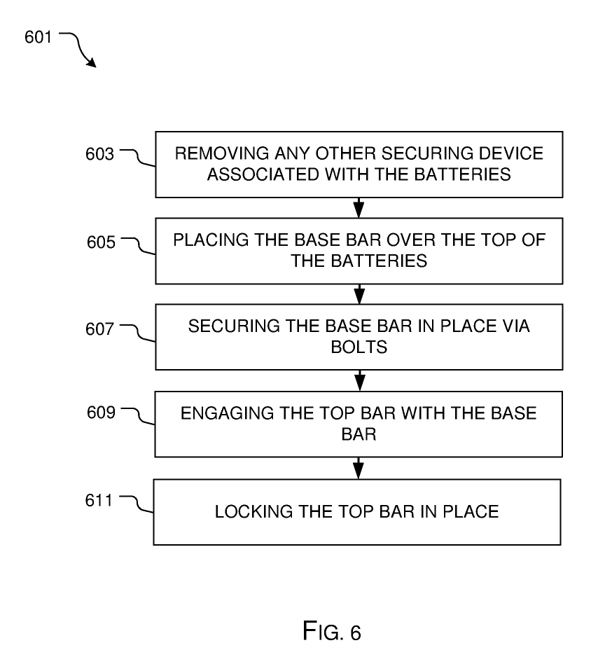

In FIG. 5, a cross sectional view further demonstrates the configuration of bar 207 securing over bar 209. In the preferred embodiment, bar 207 includes at least two sides 501, 503 configured to secure around the sides of bar 209, thereby preventing shifting and/or movement of either bar when locked together.

In FIG. 6, a flowchart 601 depicts a method of use associated with system 201. During use, any pre-existing covers, plastic retention devices, or other similar devices commonly used with vehicle battery systems are removed, as shown with box 603. The base bar is then placed over the top of the one or more batteries, wherein the bar extends over the top of all batteries, as shown with box 605. The base bar is secured in place via one or more bolts, as shown with box 607. The top bar is then engaged with the base bar and locked in place, thereby preventing access to the bolts, as shown with boxes 609, 611. In order to remove the one or more batteries, the top bar must be removed by unlocking the lock.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A battery retaining apparatus for securing one or more batteries in place within a vehicle, the battery retaining apparatus comprising:
a base bar configured to extend across the one or more batteries, the bas bar having a plurality of bolt receiving holes;
a plurality of bolts configured to insert through the plurality of bolt receiving holes;
a top bar configured to engage with the base bar to prevent access to the plurality of bolts; and
a lock extending through the top bar;
wherein the lock is configured to lock the top bar and the base bar together, thereby preventing access to the plurality of bolts; and
wherein the battery retaining apparatus prevents removal of the one or more batteries.

2. The apparatus of claim 1, wherein the top bar engages with the base bar via one or more locking slip nuts.

3. The apparatus of claim 1, wherein the lock is configured to unlock via a key.

4. The apparatus of claim 1, wherein the top bar comprises:
a top and two sides extending from the top to form a channel;
wherein the channel receives the base bar.

5. The apparatus of claim 1, wherein the base bar comprises:
a lip extending over a bottom surface of the base bar;
wherein the lip provides a structure to receive a locking lever associated with the lock to secure to the top bar to the base bar.

6. A method of securing one or more batteries in a vehicle, the method comprising:
providing the apparatus of claim 1;
removing any plastic covering associated with the one or more batteries;
placing the base bar over the top of the one or more batteries;
inserting the plurality of bolts into the plurality of bolt holes;
tightening the plurality of bolts to secure the base bar in place;
engaging the top bar with the base bar; and
locking the top bar to the base bar, thereby preventing access to the plurality of bolts.
